(19) United States
(12) Patent Application Publication
(10) Pub. No.: US 2005/0132578 A1
(43) Pub. Date: Jun. 23, 2005

(54) Saw

(76) Inventor: Joseph M. Colich, St. Louis, MO (US)

Correspondence Address: THOMPSON COBURN, LLP, ONE US BANK PLAZA, SUITE 3500, ST LOUIS, MO, 63101, US

(21) Appl. No.: 10/744,388

(22) Filed: Dec. 23, 2003

(51) Int. Cl. B26B 29/00

(52) U.S. Cl. 30/293; 30/289

(57) ABSTRACT

A saw comprises a generally planar saw blade, a handle, and a depth control guide. The blade has an arcuate cutting edge. A shank portion of the saw blade is pivotally connected to the handle in a manner to permit pivoting movement of the saw blade relative to the handle in a plane of the saw blade. The depth control guide comprises an arcuate depth control surface, which is adapted for engagement with a surface of material being cut with the saw in a manner to control cutting depth. The arcuate depth control surface has a curvature that approximates a curvature of the arcuate cutting edge of the saw blade. The depth control guide is adjustably connected to the saw blade in a manner so that the distance between the arcuate depth control surface and the arcuate cutting edge of the blade can be selectively adjusted to achieve a desired cutting depth.

### BACKGROUND OF THE INVENTION

The present invention relates to saws and, more particularly, to hand saws configured for making “flush cuts” and starter saws configured for starting cuts from within a plane of the material being cut.

Saws capable of making “flush cuts” are known in the art. Such saws are capable of cutting through a protrusion that is perpendicular to a surface in manner so that the cut is “flush” to the surface. These saws are also useful for making cuts in locations having limited clearance, such as at a corner where the planes of two surfaces meet at a 90 degree angle. Some amount of clearance is needed for the saw handle and the user's hand, which makes flush cuts of this kind difficult with a conventional saw. Therefore, many saws designed for making flush cuts include saw blades that are of sufficient flexibility to permit the blade to be “flexed” so that a portion of the blade is parallel to and flush against a surface adjacent to the material being cut. These blades also typically have little or no lateral inclination to the saw teeth, so as to avoid marring the adjacent surface. Without sufficient flexibility of the blade, clearance needed for the saw handle or user's hand may not permit a sufficiently flush cut. Known prior art flush-cutting blades have a generally straight cutting edge that is not suitable for starting cuts from within the plane of the material being cut. The distal tip of the blade may be used to start a cut from within the plane of the material, but this is an awkward and difficult exercise and also results in premature wear of the teeth at end of the blade. Known prior art flush-cutting saws also lack appropriate adjustability of the blades relative to the handles to allow access in tight locations.

Starter saws capable of starting cuts from within the plane of the material being cut (i.e, not starting from an edge of the material) are also known in the art. Some of these saws include a convex cutting edge that allows the cut to be started from within the plane of the material being cut. However, such saws typically include some set or lateral inclination to the teeth, which makes them undesirable for use in a flush cutting operation. Such saws also lack any means for accurately controlling the depth of the cut.

### SUMMARY OF THE INVENTION

In general, a saw of the present invention comprises a generally planar saw blade, a handle, and a depth control guide. The saw blade has a proximal end and a distal end. The blade has an arcuate cutting edge extending along at least a portion of the saw blade between its proximal end and distal end. The blade has a shank portion adjacent its proximal end. The handle is adapted for hand-engagement by a user. The shank portion of the saw blade is pivotally connected to the handle in a manner to permit pivoting movement of the saw blade relative to the handle in a plane of the saw blade. The depth control guide comprises an arcuate depth control surface. The arcuate depth control surface is adapted for engagement with a surface of material being cut by the saw in a manner to control cutting depth. The arcuate depth control surface has a curvature that approximates a curvature of the arcuate cutting edge of the saw blade. The depth control guide is adjustably connected to the saw blade in a manner so that the distance between the arcuate depth control surface and the arcuate cutting edge of the blade can be selectively adjusted to achieve a desired cutting depth.

In another aspect of the invention, a saw comprises a generally planar saw blade and a depth control guide. The saw blade has an arcuate cutting edge with a fixed radius of curvature. The depth control guide comprises an arcuate depth control surface that is configured for engagement with a surface of material being cut in a manner to control cutting depth. The depth control guide is movably connected to the saw blade in a manner so that a distance between the arcuate depth control surface and the arcuate cutting edge of the saw blade can be selectively adjusted to achieve a desired cutting depth. The arcuate depth control surface has an adjustable radius of curvature.

In still another aspect of the invention, a saw comprises a generally planar saw blade and a depth control guide. The saw blade is formed of a ferromagnetic material and has a cutting edge. The depth control guide has a depth control surface that is adapted for engagement with a surface of material being cut in a manner to control cutting depth. The depth control guide has at least one magnet. The depth control guide is adjustably connected to the saw blade via the magnet in a manner so that a distance between the depth control surface and the cutting edge of the saw blade can be selectively adjusted to achieve a desired cutting depth.

In a further embodiment of the present invention, a saw comprises a generally planar saw blade and a depth control guide. The saw blade has an arcuate cutting edge. The depth control guide comprises an arcuate depth control surface that is configured for engagement with a surface of material being cut in a manner to control cutting depth. The arcuate depth control surface has a curvature that approximates a curvature of the arcuate cutting edge of the saw blade. The depth control guide is adjustably connected to the saw blade in a manner so that a distance between the arcuate depth control surface and the arcuate cutting edge of the saw blade can be selectively adjusted to achieve a desired cutting depth.

Further features and advantages of the present invention, as well as the structure and operation of various embodiments of the present invention, are described in detail below with reference to the accompanying drawings.

### BRIEF DESCRIPTION OF THE DRAWINGS

FIG. 1 is a perspective view of a saw of the present invention, with a handle portion shown in a first position;

FIG. 2 is an exploded perspective view of the saw of FIG. 1, showing the assembly of its various components;

FIG. 3 is a side elevational view of the saw of FIG. 1, with the handle shown in a second position;

FIG. 4 is a top plan view of the saw of FIG. 3;

FIG. 5 is a top plan view of the depth control guide, removed from the saw of FIG. 3;

FIG. 6 is a front end elevational view of the saw of FIG. 3; and

FIG. 7 is a side elevational view of an alternate embodiment of a saw of the present invention.

Reference characters used in these Figures correspond to reference characters used throughout the following detailed description of the preferred embodiments.

### DETAILED DESCRIPTION OF THE PREFERRED EMBODIMENTS

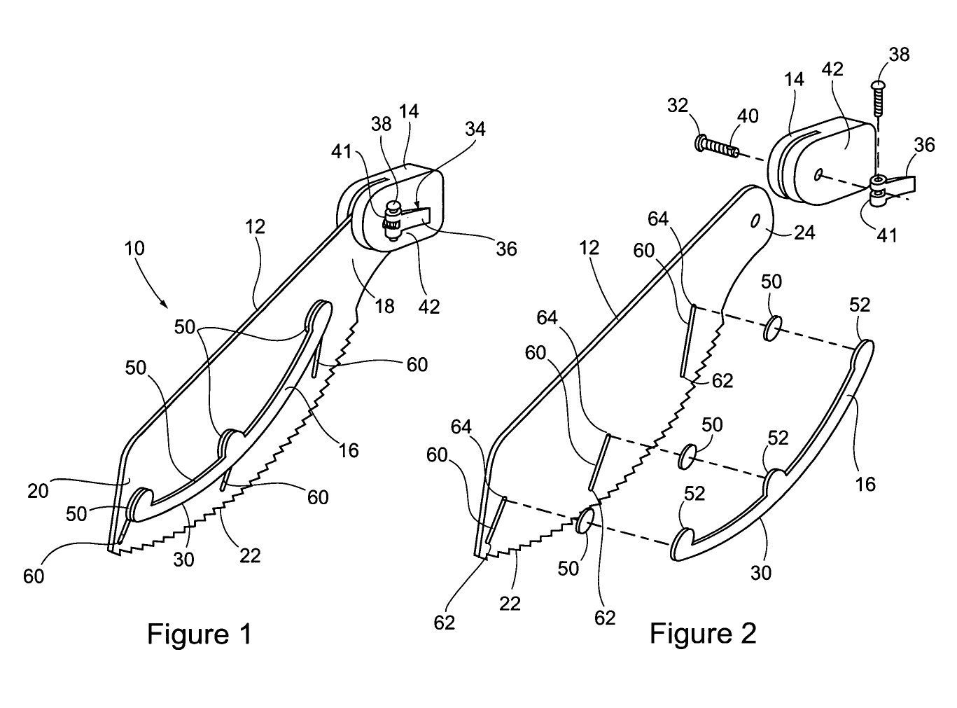

A saw of the present invention is represented in its entirety in FIG. 1 by the reference numeral 10. In general, the saw 10 comprises a saw blade 12, a handle 14 and a depth control guide 16. The saw blade 12 is generally planar and has a proximal end 18 and a distal end 20. Preferably, the blade 12 has an arcuate cutting edge 22, which extends along the saw blade between its proximal and distal ends. As best shown in FIG. 2, the proximal end 18 of the blade 12 includes a shank portion 24. The handle 14 is adapted for hand-engagement by a user (not shown). Preferably, the handle 14 and the shank portion 24 of the blade 12 are pivotally connected to one another in a manner to permit pivoting movement of the blade 12 relative to the handle 14 in a plane of the blade 12. The depth control guide 16 comprises an arcuate depth control surface 30, which is preferably generally perpendicular to the plane of the saw blade 12. As explained hereinafter, the arcuate depth control surface 30 is adapted for abutting engagement with a surface (not shown) of material being cut with the saw 10 in a manner to control cutting depth. As explained below, the depth control guide 16 is adjustably connected to the blade 12 in a manner so that a distance between the arcuate depth control surface 30 and the arcuate cutting edge 22 of the blade 12 can be selectively adjusted to achieve a desired cutting depth.

As shown in the Figures, the handle 14 resembles a clevis with a slot dimensioned to receive the shank portion 24 of the blade 12 therein. A pivot pin 32 engages both the handle 14 and the shank portion 24 in a manner to permit pivoting movement of the blade 12 relative to the handle 14 in a plane of the blade 12. Preferably, the saw 10 further comprises a locking mechanism 34 including a hand-operable locking member 36 that is operatively connected to the handle 14 in manner so that the relative positions of the saw blade 12 and handle 14 can be locked and unlocked by rotating the locking member 36 relative to the handle 14 about a locking pin 38. The pivot pin 32 includes a hole 40 (see FIG. 2) that is sized to receive the locking pin 38, and thereby secure the pivot pin 32, locking member 36 and locking pin 38 to the handle 14. The locking member 36 includes a cam surface 41 that firmly engages an outer surface 42 of the handle 14 (when the locking member 36 is in its locked position) and squeezes the shank portion 24 between the two sides of the clevis of the handle 14 with enough force to maintain the relative positions of the blade 12 and handle 14 by friction. The locking member 36 is rotatable by hand (i.e., without tools) to an unlocked position, wherein the cam surface 41 disengages the outer surface 42 of the handle 14 (or at least reduces its force against the handle) so that the blade 12 may be pivoted relative to the handle 14. Adjustment of the blade 12 relative to the handle 14 in this manner allows access in restrictive places.

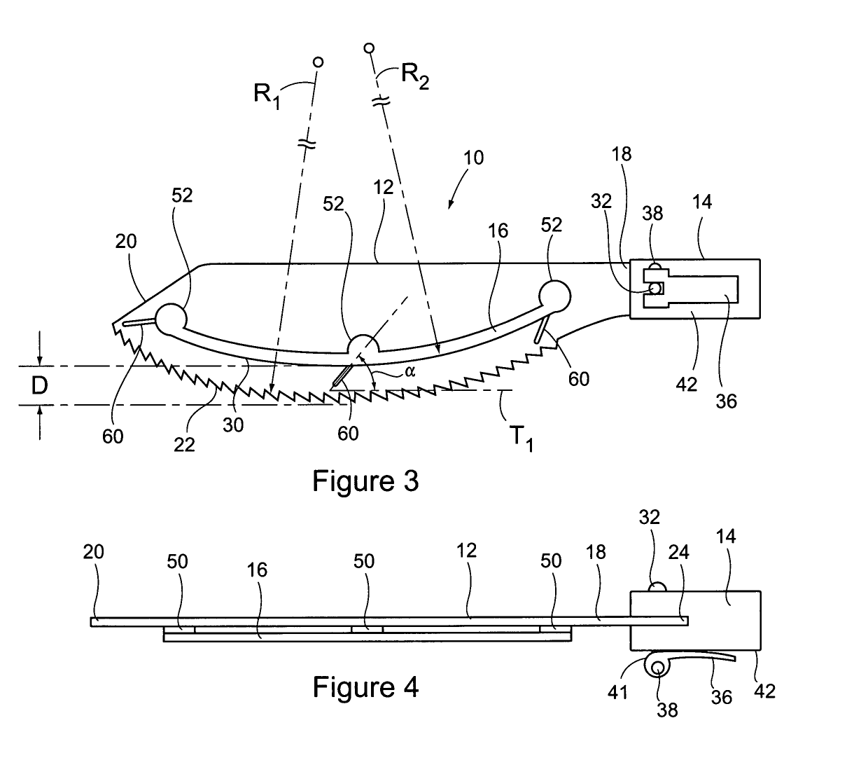

As best shown in FIG. 3, the cutting edge 22 of the blade 12 has an arcuate (preferably convex) configuration. The arcuate cutting edge 22 preferably has a radius of curvature that facilitates starting a cut from within the plane of the material being cut. The pivotal connection between the blade 12 and the handle 14 permits adjustment of the blade 12 to allow tangential contact of the arcuate cutting edge 22 with the work piece at a variety of positions along the blade length.

Preferably, the saw blade 12 is of a flexible material, e.g., relatively thin gauge steel, that permits flexion of the blade 12 in a plane that is generally perpendicular to the plane of the saw blade and that is also generally parallel to at least a portion of the cutting edge (i.e., side to side relative to the line of cut). Again, this flexibility permits flush cutting operations. Preferably, there is little or no lateral inclination to the cutting teeth so as to avoid marring the adjacent surface during a flush cutting operation.

The arcuate cutting edge 22 of the blade 12 will have a fixed radius of curvature R₁. Again, the arcuate depth control surface 30 of the depth control guide 16 is adapted for abutting engagement with a surface of the material being cut in a manner to control cutting depth, and the depth control guide 16 is preferably adjustable relative to the blade 12 so that the distance between the arcuate depth control surface 30 and the arcuate cutting edge 22 of the blade 12 can be selectively adjusted to achieve a desired cutting depth. As best shown in FIG. 3, the arcuate depth control surface 30 preferably has a curvature that approximates a curvature of the arcuate cutting edge 22 of the saw blade 12. Thus, the spacing between the arcuate cutting edge 22 and the arcuate depth control surface 30 will be substantially constant along the entire length of the arcuate cutting edge 22.

In the preferred embodiment of the invention, at least a portion of the depth control guide 16 is of a flexible and resilient material (e.g., molded Nylon) that permits flexion of the arcuate depth control surface 30 in a plane that is generally parallel to a plane of the saw blade (i.e., side to side relative to the line of cut). Thus, the depth control guide 16 will flex along with the blade 12 even when the blade 12 is flexed substantially during a flush cutting operation.

Preferably, the arcuate depth control surface 30 of the depth control guide 16 has an adjustable radius of curvature R₂. As explained below, the depth control guide 16 is preferably configured in a manner so that the radius of curvature R₂ of the arcuate depth control surface 30 decreases as the depth control guide 16 is moved relative to the saw blade 12 in a direction (upwardly as viewed in FIG. 3) that increases the distance D between the arcuate depth control surface 30 and the arcuate cutting edge 22, and so that radius of curvature R₂ of the arcuate depth control surface 30 increases as the distance D decreases. Thus, the radius of curvature R₂ of the arcuate depth control surface 30 varies in a manner so that an arc of curvature of the arcuate depth control surface 30 will remain substantially concentric with an arc of curvature of the arcuate cutting edge 22 as the depth control guide 16 is moved relative to the saw blade 12 to adjust cutting depth. This ensures a substantially constant distance between the arcuate depth control surface 30 and the arcuate cutting edge 22 along substantially the entire length of the arcuate cutting edge 22.

Again, at least a portion of the depth control guide 16 is of a flexible and resilient material (e.g., molded Nylon) that permits flexion of the arcuate depth control surface 30 in a plane that is generally parallel to a plane of the saw blade. This material also preferably permits some degree of flexion and resilience with a plane of the depth control guide 16, generally parallel to the blade. Preferably, the depth control guide 16 is molded in a manner so that the arcuate depth control surface 30 has a nominal radius of curvature (i.e., a radius of curvature at equilibrium, when not undergoing any elastic deformation) that approximates the radius of curvature R₁ of the arcuate cutting edge 22 of the saw blade 12. Thus, preferably, movement of the depth control guide 16 in a direction (upwardly as viewed in FIG. 3) that increases the distance D between the arcuate depth control surface 30 and the arcuate cutting edge 22 results in some degree of elastic deformation of the depth control guide 16, as the depth control guide 16 is flexed to decrease the radius of curvature R₂ of the arcuate depth control surface 30. This elastic deformation results in a restoring force that resists further movement of the depth control guide 16 in that direction. The resistance against further upward movement helps to maintain the relative positions of the depth control guide 16 and blade 12 when the arcuate depth control surface 30 is subjected to external normal forces due to its abutting engagement with the work piece being cut.

Preferably, the saw blade 12 is of a ferromagnetic material (e.g. steel) and the depth control guide 16 includes at least one magnet 50 for connecting the depth control guide 16 to the saw blade 12. More preferably, the depth control guide 16 includes a plurality of such magnets 50 and the depth control guide 16 is connected to the saw blade 12 only via the magnets 50. As shown in FIG. 3, the depth control guide 16 preferably includes a plurality of enlarged portions or bosses 52 to which the magnets are permanently affixed, such as with a suitable adhesive or other appropriate bond.

In the preferred embodiment of the invention, the magnets comprise rare earth magnets (e.g., Alnico, Neodymium or Samarian Cobalt). Rare earth magnets are preferred because of their significant magnetic strength relative to their size and weight. However, other types of magnetic materials or non-magnetic fasteners could be used without departing from the scope of the invention as claimed hereinafter. Preferably, the magnets 50 are of sufficient strength to resist movement of the depth control guide 16 relative to the arcuate cutting edge 22 of the saw blade 12 when the depth control guide 16 is subjected to external normal forces exerted on the arcuate depth control surface 30 by a surface of material being cut during a normal cutting operation. This, coupled with the internal restoring forces of the depth control guide 16 caused by the elastic deformation of the depth control guide 16, will preferably be sufficient to prevent unwanted movement of the depth control guide 16 relative to the arcuate cutting edge 22 during a normal cutting operation.

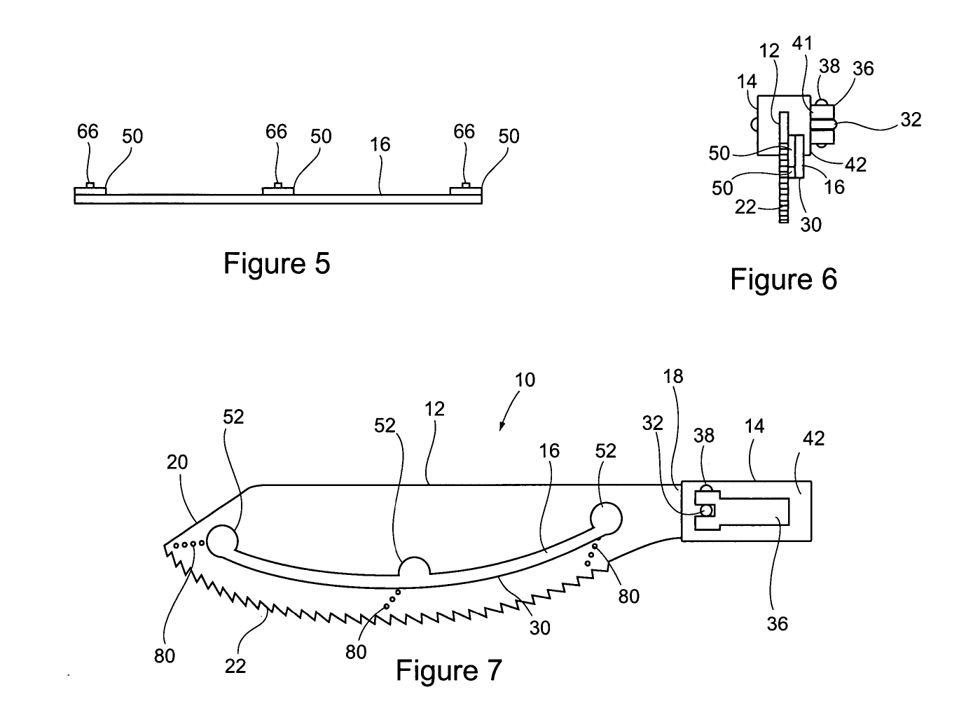

As best shown in the exploded view of FIG. 2, the saw blade 12 preferably includes a plurality of slots 60, each of the slots 60 corresponding to one of the magnets 50. Each slot has a lower end 62 generally adjacent the arcuate cutting edge 22 of the blade and an upper end 64 that is spaced from the arcuate cutting edge 22 of the blade 12. As shown in FIG. 5, each of the magnets 50 preferably includes a projection 66 that is dimensioned to engage its corresponding slot 60 in a manner to permit sliding movement of the magnet 60 relative to the blade 12 along the slot 60 in a manner to permit adjustment of the position of depth control guide 16 relative to the arcuate cutting edge 22 of the saw blade 12 to achieve the desired cutting depth. Thus, adjustment of the position of depth control guide 16 relative to the arcuate cutting edge 22 of the saw blade 12 can be accomplished without tools.

Preferably, the slots 60 are located along the saw blade 12 in a generally symmetrical manner and the magnets 50 are located along the depth control guide 16 in a correspondingly generally symmetrical manner (i.e., the magnets are positioned along the depth control guide 16 in a manner so that the spacings between the magnets is generally even) so that the depth control guide 16 may be used on either side of the saw blade 12. This will allow the blade 12 to be used for a flush cutting operation on either side.

As best shown in FIGS. 2 and 3, the slots 60 are not parallel with one another. Instead, the slots 60 are preferably oriented relative to one another so that the spacing between the lower ends 62 of the slots 60 is greater than the spacing of the upper ends 64 of the slots 64. This forces flexion of the depth control guide 16 in a plane parallel to the blade 12 as the depth control guide 16 is moved away from the arcuate cutting edge 22 to increase cutting depth. The radius of curvature R₂ of the arcuate depth control surface 30 decreases as the magnets 50 slide along their respective slots 60 during movement of the depth control guide 16 away from the arcuate cutting edge 22 (upwardly as viewed in FIG. 3) to increase cutting depth. As discussed above, this reduction in the radius of curvature R₂ of the arcuate depth control surface 30 serves to maintain a generally constant spacing between the arcuate depth control surface 30 and the arcuate cutting edge 22 of the saw blade 12 along the length of the arcuate cutting edge 22, and thereby ensures that the arcuate depth control surface 30 and the arcuate cutting edge 22 of the blade 12 will remain substantially concentric.

Preferably, the slots 60 are oriented at an angle relative to the arcuate cutting edge 22 so that external normal forces exerted on the depth control guide 16 by the work piece during cutting are not acting parallel to the slot. Ideally, the slots 60 are oriented at an angle that will result in the external normal forces acting in a direction that is generally perpendicular to the slots 60. The orientation of the slots 60 shown in the Figures is intended for blade teeth that are set to cut on a pull stroke. As the saw blade 12 is pulled (generally to the right as viewed in FIG. 3), external normal forces exerted on the depth control guide 16 will be acting in a direction that is generally upwardly and to the left (as viewed in FIG. 3). In the case of a saw blade that is designed for blade teeth that are set to cut on a push stroke, the slots 60 may be oriented in the opposite direction. As shown in FIG. 3, for each slot 60, an imaginary line T₁ that is tangent to and intersecting with the arcuate cutting edge 22 at a point adjacent the lower end 62 of the slot 60 forms an acute angle α with the slot 60. Preferably, this angle is between about 30 and 60 degrees, though other angles or slot orientations could be used without departing from the scope of the invention as claimed hereinafter.

Thus, in the preferred embodiment of the invention shown in the Figures, the strength of the magnets 50, the internal restoring forces caused by the elastic deformation of the depth control guide 16, and the angled orientation of the slots 60, will together resist unwanted movement of the depth control guide 16 relative to the arcuate cutting edge 22 during a normal cutting operation.

In an alternative embodiment of the invention shown in FIG. 7, slots are replaced by a series of holes 80. Each of these holes 80 is preferably dimensioned to receive the projection 66 of one of the magnets 50. Preferably, the holes 80 are located in substantially the same positions as the slots 60 or the previously described embodiment. Thus, adjustment of the position of depth control guide 16 relative to the arcuate cutting edge 22 of the saw blade 12 to achieve the desired cutting depth is accomplished by engaging the magnets 50 with selected holes 80.

While the present invention has been described by reference to specific embodiments and specific uses, it should be understood that other configurations and arrangements could be constructed, and different uses could be made, without departing from the scope of the invention as set forth in the following claims.

1. A saw comprising:
a generally planar saw blade having a proximal end and a distal end, the saw blade having an arcuate cutting edge extending along at least a portion of the saw blade between its proximal and distal ends, the saw blade having a shank portion adjacent its proximal end;
a handle adapted for hand-engagement by a user, the shank portion of the saw blade being pivotally connected to the handle in a manner to permit pivoting movement of the saw blade relative to the handle in a plane of the saw blade; and
a depth control guide comprising an arcuate depth control surface that is adapted for engagement with a surface of material being cut with the saw in a manner to control cutting depth, the arcuate depth control surface having a curvature that approximates a curvature of the arcuate cutting edge of the saw blade, the depth control guide being adjustably connected to the saw blade in a manner so that a distance between the arcuate depth control surface and the arcuate cutting edge of the saw blade can be selectively adjusted to achieve a desired cutting depth.

2. The saw of claim 1 wherein the saw blade is of a ferromagnetic material and wherein depth control guide includes at least one magnet, the depth control guide being connected to the saw blade via the magnet.

3. The saw of claim 2 wherein the at least one magnet is of sufficient strength and size to prevent the depth control guide from moving relative to the arcuate cutting edge of the saw blade when the depth control guide is subjected to external forces exerted on the depth control guide by a surface of material being cut during a normal cutting operation.

4. A saw comprising:
a generally planar saw blade with an arcuate cutting edge with a fixed radius of curvature; and
a depth control guide comprising an arcuate depth control surface that is configured for abutting engagement with a surface of material being cut in a manner to control cutting depth, the depth control guide being movably connected to the saw blade in a manner so that a distance between the arcuate depth control surface and the arcuate cutting edge of the saw blade can be selectively adjusted to achieve a desired cutting depth, the arcuate depth control surface having an adjustable radius of curvature.

5. The saw of claim 4 wherein at least a portion of the depth control guide is of a flexible material that permits flexion of the arcuate depth control surface in a plane that is generally parallel to a plane of the saw blade.

6. The saw of claim 5 wherein the depth control guide is configured in a manner so that the radius of curvature of the arcuate depth control surface decreases as the depth control guide is moved relative to the saw blade in a direction that increases the distance between the arcuate depth control surface and the arcuate cutting edge.

7. The saw of claim 5 wherein the depth control guide is connected to the saw blade in a manner so that the radius of curvature of the arcuate depth control surface decreases as the distance between the arcuate depth control surface and the arcuate cutting edge increases.

8. The saw of claim 5 wherein the radius of curvature of the arcuate depth control surface varies in a manner so that an arc of curvature of the arcuate depth control surface will remain substantially concentric with an arc of curvature of the arcuate cutting edge as the depth control guide is moved relative to the saw blade to adjust cutting depth.

9. The saw of claim 5 wherein at least a portion of the depth control guide is of a resilient material that is molded in a manner so that the arcuate depth control surface has a nominal radius of curvature that approximates the radius of curvature of the arcuate cutting edge of the saw blade.

10. The saw of claim 9 wherein movement of the depth control guide in a direction that increases the distance between the arcuate depth control surface and the arcuate cutting edge of the saw blade results in elastic deformation of the resilient portion of the depth control guide, resulting in a restoring force that resists further movement of the depth control guide in that direction.

11. The saw of claim 5 wherein the saw blade is of a ferromagnetic material and wherein depth control guide includes a plurality of magnets which are fixed in their respective positions on the depth control guide, the depth control guide being connected to the saw blade via the magnets, the saw blade including a plurality of slots, each of said slots corresponding to one of said magnets, each of said slots having a first end generally adjacent the arcuate cutting edge of the blade and a second end that is spaced from the arcuate cutting edge of the blade, each magnet having a projection dimensioned to engage its corresponding slot in a manner to permit sliding movement of the magnet relative to the blade along the slot in a manner to adjust the position of depth control guide relative to the arcuate cutting edge of the saw blade to achieve the desired cutting depth.

12. The saw of claim 1 wherein the slots are oriented relative to one another in a manner so that the radius of curvature of the arcuate depth control surface decreases as the magnets slide along their respective slots during movement of the depth control guide away from the arcuate cutting edge of the saw blade to increase cutting depth.

13. A saw comprising:
a generally planar saw blade formed of a ferromagnetic material, the saw blade having a cutting edge; and
a depth control guide comprising a depth control surface that is adapted for abutting engagement with a surface of material being cut in a manner to control cutting depth, the depth control guide having at least one magnet, the depth control guide being adjustably connected to the saw blade via the magnet in a manner so that a distance between the depth control surface and the cutting edge of the saw blade can be selectively adjusted to achieve a desired cutting depth.

14. The saw of claim 13 wherein the depth control surface is generally perpendicular to the plane of the saw blade.

15. The saw of claim 13 wherein the at least one magnet is of sufficient strength size to prevent the depth control guide from moving relative to the cutting edge of the saw blade when the depth control guide is subjected to external forces exerted on the depth control guide by a surface of material being cut during a normal cutting operation.

16. The saw of claim 13 wherein the saw blade and depth control guide are of flexible materials that permit flexion of the saw blade and depth control guide in a plane that is generally perpendicular to the plane of the saw blade and that is also generally parallel to at least a portion of the cutting edge.

17. The saw of claim 13 wherein the saw blade includes at least one slot having a first end generally adjacent the cutting edge of the blade and a second end that is spaced from the cutting edge of the blade, and wherein the magnet includes a projection dimensioned for engagement with the slot in a manner to permit sliding movement of the magnet relative to the blade along the slot in a manner so that the position of the depth control guide may be adjusted relative to the cutting edge of the saw blade to achieve the desired cutting depth.

18. The saw of claim 17 wherein the slot is oriented at an angle relative to the cutting edge so that external forces acting on the depth control guide during cutting are not parallel to the slot.

19. The saw of claim 17 wherein the magnet is one of a plurality of such magnets, and wherein the slot is one of a plurality of such slots, each of said slots corresponding to one of said magnets.

20. The saw of claim 19 wherein the slots are located along the saw blade in a generally symmetrical manner and the magnets are located along the depth control guide in a correspondingly generally symmetrical manner so that the depth control guide may be used on either side of the saw blade.

21. The saw of claim 19 wherein cutting edge of the saw blade is an arcuate cutting edge.

22. The saw of claim 21 wherein the depth control surface of the depth control guide is an arcuate surface having a curvature that approximates a curvature of the arcuate cutting edge of the saw blade.

23. The saw of claim 22 wherein the depth control guide is of a flexible material that permits flexion of the depth control guide in a plane that is generally parallel to the plane of the saw blade, and wherein the slots are oriented relative to one another in a manner so that a radius of curvature of the arcuate depth control surface decreases as the depth control guide is moved away from the arcuate cutting edge of the saw blade to increase cutting depth, thereby maintaining a generally constant spacing between the arcuate depth control surface and the arcuate cutting edge of the saw blade along the length of the arcuate cutting edge.

24. The saw of claim 21 wherein at least a portion of the arcuate cutting edge of the saw blade has a convex configuration.

25. A saw comprising:
a generally planar saw blade with an arcuate cutting edge; and
a depth control guide comprising an arcuate depth control surface that is configured for abutting engagement with a surface of material being cut in a manner to control cutting depth, the arcuate depth control surface having a curvature that approximates a curvature of the arcuate cutting edge of the saw blade, the depth control guide being adjustably connected to the saw blade in a manner so that a distance between the arcuate depth control surface and the arcuate cutting edge of the saw blade can be selectively adjusted to achieve a desired cutting depth.

26. The saw of claim 25 wherein the saw blade includes a shank portion, and wherein the saw further comprises a handle adapted for hand-engagement by a user, the shank portion of the saw blade being pivotally connected to the handle in a manner to permit pivoting movement of the saw blade relative to the handle in a plane of the saw blade.

27. The saw of claim 26 wherein saw further comprises a hand-operable locking member that is operatively connected to the handle in manner so that the relative positions of the saw blade and handle can be locked and unlocked by rotating the locking member relative to the handle.

28. The saw of claim 27 wherein the hand-operable locking member is moveable between an unlocked position and a locked position, the locking member having a cam surface that engages an outer surface of the handle in a manner to lock the relative positions of the saw blade and handle when the locking member is in its locked position.

29. The saw of claim 25 wherein the saw blade is of a ferromagnetic material and wherein depth control guide includes at least one magnet, the depth control guide being connected to the saw blade via the magnet.

30. The saw of claim 29 wherein the at least one magnet is of sufficient strength and size to prevent the depth control guide from moving relative to the arcuate cutting edge of the saw blade when the depth control guide is subjected to external forces exerted on the depth control guide by a surface of material being cut during a normal cutting operation.

31. The saw of claim 29 wherein the saw blade includes at least one slot having a first end generally adjacent the arcuate cutting edge of the blade and a second end that is spaced from the arcuate cutting edge of the blade, and wherein the magnet includes a projection dimensioned to engage the slot in a manner to permit sliding movement of the magnet relative to the blade along the slot in a manner so that the position of depth control guide relative to the arcuate cutting edge of the saw blade may be adjusted to achieve the desired cutting depth.

32. The saw of claim 31 wherein a line tangent to and intersecting with the arcuate cutting edge at a point adjacent the first end of the slot forms an acute angle with the slot.

33. The saw of claim 31 wherein the magnet is one of a plurality of such magnets, and wherein the slot is one of a plurality of such slots, each of said slots corresponding to one of said magnets.

34. The saw of claim 33 wherein the slots are located along the saw blade in a generally symmetrical manner, and wherein the magnets are located along the depth control guide in a correspondingly generally symmetrical manner so that the depth control guide may be used on either side of the saw blade.

35. The saw of claim 33 wherein the depth control guide is of a flexible material that permits flexion of the depth control guide in a plane that is generally parallel to a plane of the saw blade, and wherein the slots are oriented relative to one another in a manner so that a radius of curvature of the arcuate depth control surface decreases as the depth control guide is moved away from the arcuate cutting edge of the saw blade to increase cutting depth, thereby maintaining a generally constant spacing between the arcuate depth control surface and the arcuate cutting edge of the saw blade along the length of the arcuate cutting edge.

36. The saw of claim 25 wherein at least a portion of the arcuate cutting edge of the saw blade has a convex configuration.

37. The saw of claim 25 wherein the saw blade and depth control guide are of flexible materials that permit flexion of the saw blade and depth control guide in a plane that is generally perpendicular to a plane of the saw blade and that is also generally parallel to at least a portion of the arcuate cutting edge.
